(19) United States
(12) Patent Application Publication
(10) Pub. No.: US 2013/0218653 A1
(43) Pub. Date: Aug. 22, 2013

(54) OFFER MANAGEMENT AND SETTLEMENT IN A PAYMENT NETWORK WITH TRANSACTION DATA

(71) Applicant: JINGIT, LLC, (US)

(72) Inventors: Todd A. Rooke, Waconia, MN (US); Joseph Rogness, JR., Eden Prairie, MN (US)

(73) Assignee: JINGIT, LLC, Edina, MN (US)

(21) Appl. No.: 13/740,892

(22) Filed: Jan. 14, 2013

Related U.S. Application Data
(63) Continuation of application No. 13/624,517, filed on Sep. 21, 2012.
(60) Provisional application No. 61/537,316, filed on Sep. 21, 2011.

(51) Int. Cl. G06Q 30/02

(52) U.S. Cl. CPC G06Q 30/0215
USPC 705/14.17

(57) ABSTRACT

A payment network for facilitating transactions involves management of offers and accounts associated with a consumer. During a transaction, the payment network can associate one or more offers and accounts in settling a transaction. Once the offer and accounts have been associated with the transaction, the payment network can adjust a transaction amount and/or identify amounts to be debited for each account associated with the transaction.

### CROSS-REFERENCE TO RELATED APPLICATION

This application is a continuation of U.S. application Ser. No. 13/624,517, filed Sep. 21, 2012, which claims priority under 35 U.S.C. §119(e) to U.S. Provisional Patent Application Ser. No. 61/537,316 filed on Sep. 21, 2011, and incorporated herein by reference.

### BACKGROUND

Companies continue to strive to maintain customers through loyalty programs and by providing various incentives. Current programs and incentives can be difficult and time consuming for companies to implement and be prone to fraud and error. Further still, these programs and incentives can be ineffective in targeting loyal and willing customers. Additionally, managing programs among numerous brands, merchants and consumers can be disparate and provide consumers with confusion and general disinterest with joining one or more loyalty programs.

### SUMMARY OF THE INVENTION

A payment network for facilitating transactions involves management of offers and accounts associated with a consumer. During a transaction, the payment network can associate one or more offers and accounts in settling a transaction. Once the offers and accounts have been associated with the transaction, the payment network can adjust a transaction amount and/or identify amounts to be debited for each account associated with the transaction.

### BRIEF DESCRIPTION OF THE DRAWINGS

FIG. 1 is a schematic diagram of a transaction environment including a payment network.

FIG. 2 is flow diagram of a method for facilitating a transaction.

FIG. 3 is a schematic block diagram of logic components utilized in facilitating a transaction.

FIGS. 4A-4F are flow diagrams of various transaction scenarios within a payment network.

FIG. 5A is schematic diagram of a virtual wallet prior to a transaction.

FIG. 5B is a schematic diagram of successive displays during a transaction using the virtual wallet illustrated in FIG. 5A.

FIG. 5C is a schematic diagram of a digital wallet following a transaction reference in FIG. 5B

FIG. 5D is a schematic block diagram of components utilized in facilitating transaction referenced in FIGS. 5A-5C.

FIG. 6A is flow diagram of a method for initiating an offer campaign.

FIG. 6B is an exemplary filter for identifying relevant offers of an offer campaign.

FIG. 6C is schematic diagram for managing an offer campaign.

FIG. 7 is a flow diagram of a method for facilitating an offer program.

FIG. 8 is flow diagram of a method for calculating tax in a transaction.

### DETAILED DESCRIPTION

Concepts presented herein relate to offer management and settlement in a payment network for presenting offers to consumers regarding goods and/or services, facilitate processing a transaction associated with the offer and settling a transaction to compensate one or more parties associated with the transaction. To that end, the concepts disclosed herein can be utilized in conjunction with a suitable engagement and payment processing platform, such as that disclosed in U.S. patent application Ser. Nos. 13/306,947 and 13/537,048, filed Nov. 29, 2011 and Jun. 29, 2012, respectively, copies of which are incorporated herein by reference.

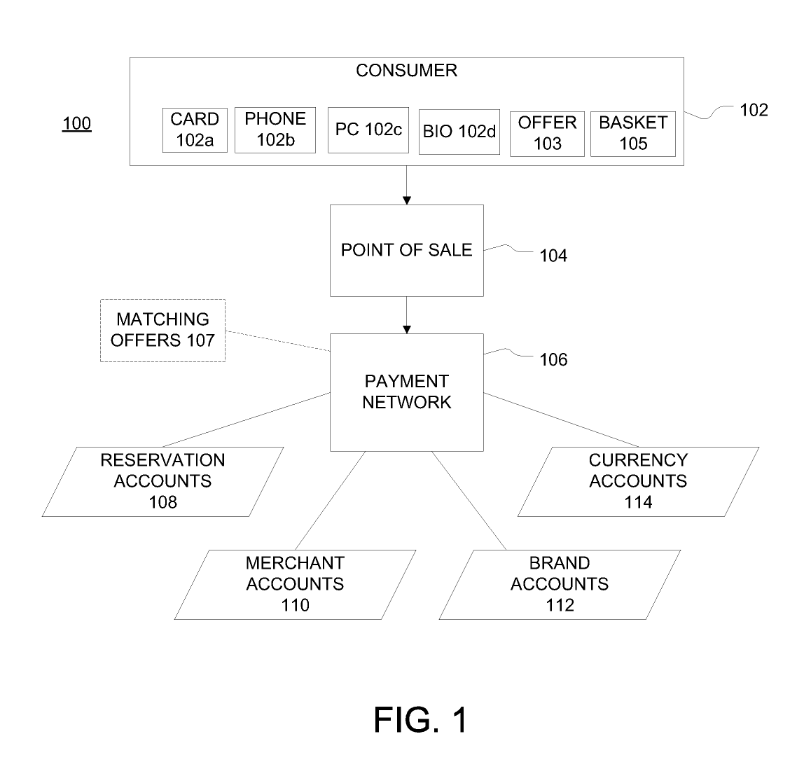

FIG. 1 is a schematic diagram of a transaction environment 100 in which a consumer 102 purchases goods and/or services communicating with one or more identifiers 102a-d. In particular, the consumer 102 uses an offer 103 from a merchant associated with a point of sale 104 during a transaction. In particular, the consumer prepares a basket 105 of one or more items for purchase. A payment network 106 facilitates the transaction between the consumer 102 and point of sale 104 and can operate to manage the offer 103 and settle the transaction as discussed in more detail below.

As identifiable by the payment network 106, the consumer 102 is associated with a unique consumer identifier 102a-d and that references a consumer profile including one or more components indicative of personally identifiable information (PII) such as name, address, zip code, phone number, email address, purchase history, product preferences, etc. The consumer 102 can further provide limitations to the payment network 106 as to what information is shared with third parties (if any, including the point of sale 104). In this manner, the consumer 102 is provided with a level of confidence about his or her personal information and can easily interact with point of sale 104 based on a relationship and preferences used by payment network 106. Furthermore, the consumer 102 can selectively share one ore more PII elements on opt in basis per party (e.g. Brand, Merchant, Publishers, etc) and optionally link an associated identifier with the party (e.g. Merchant Reward #, Brand Loyalty ID, subscriber #, etc.) Additionally, the consumer can link their profile with a social networking profile (e.g. Facebook, Twitter, LinkedIn, Google+, etc). In one further embodiment, the consumer 102 can interact with the point of sale without sharing PII.

In one example transaction, a purchase can be based on an offer 103 presented to the consumer 102, for example through an engagement management system as discussed in the aforementioned patent applications. An offer 103, as used herein, can be any form of coupon, discount, rebate, proposal, etc. associated with consumer activity and presented as an incentive for the consumer to commence a specified transaction. Stated another way, an offer provides compensation, discount or other form of value to a consumer for performing at least one action for acceptance of the offer 103. The offer 103 can be a physical identifier or can be digitally stored on a device and uniquely associated with the consumer 102 so as to prevent unauthorized duplication and/or fraud associated with the offer. In one embodiment, offers 103 can be limited to a household comprising multiple consumers. In further embodiments, offers 103 can have different values associated with different consumers based on a plurality of targeting criteria.

Consumer 102 is presented with the offer 103 and communicates one or more of the identifiers 102a-d with a point of sale 104 that is associated with the merchant to conduct a transaction. Identifiers 102a-d are intended to be illustrative only, and include a card 102a (e.g., a debit or credit card, unique card specifically issued by or in connection with the payment network 106), a phone 102b (e.g., phone number with pin, short message service (sms), a smart phone including an app, a code generator, a near field communication transmitter, a wireless communication transmitter, etc.), a personal computer 102c (e.g., a desktop computer, laptop computer, tablet computer) and a biological identifier 102d (e.g., finger print scan, retina scan, voice verification). In one example, the point of sale 104 can be a cash register at a conventional brick and mortar retail store or a website presented to the consumer 102, whereas the offer 103 could be presented to the consumer 102 digitally through the Internet. The point of sale 104 can include an interaction available through the payment network such as a customized payment button, a mobile app, a gaming interaction, etc. The transaction between the consumer 102 and point of sale 104 includes transaction information such as a customer identifier, a merchant identifier, a date and time, a level of interactivity, a consumer location, a merchant location and/or other information. By tying offers 103 to a specific transaction and/or consumer 102, fraud and/or unintended credits for items, even items that have been returned, can be prevented.

Further to the transaction information identified above, the transaction information can include a basket 105 (i.e., either physical or virtual) prepared by the consumer 102 containing one or more goods and services for purchase. In one embodiment, items in the basket 105 can each include a universal processing code (UPC), or equivalent, that uniquely identifies products within the basket 105. The point of sale 104 interfaces with a payment network 106 to identify the consumer 102 and offer 103 based on information presented by the consumer 102 (or consumer device) at the point of sale 104.

In one embodiment, the payment network 106 can evaluate contents of the basket 105 of goods for purchase by consumer 102 to match any other offers (shown as matching offers 107) that are associated with the consumer 102 as it pertains to contents in the basket 105. For example, a particular brand of shoes may have a matching offer 107 for a $10.00 rebate for purchasing a specific pair of shoes. If the consumer 102 has the pair of shoes in the basket 105, $10.00 will be credited to the consumer 102 upon checkout as will be discussed in more detail below. Alternatively, or in addition to, a merchant may present a matching offer 107 based on one or more of the products in the basket 105 and/or based on a total of all products in the basket. For example, a merchant may offer a $10.00 rebate for total purchases in excess of $50.00. The network 106 can evaluate the basket and determine whether the contents exceed the $50.00 threshold. If the threshold is exceeded, the $10.00 rebate is applied during settlement. Adjustments to the transaction amount based on the offer 103 can be facilitated by the network 106 with varying levels of integration with the point of sale 104.

The interface between point of sale 104 and payment network 106 can be a direct connection, wherein payment network 106 has access to all information processed by point of sale 104. In another embodiment, the payment network can have an extension of its system in close proximity to the point of sale 104 such that the performance of the system can satisfy the latency requirements of the merchant. In a further embodiment, the payment network 106 can be connected to the point of sale 104 through one or more intermediaries and lack complete transaction information otherwise accessible by the point of sale 104. In this embodiment, the payment network 106 is equipped to manage and implement one or more offers 103 and/or offers 107 so as to settle the transaction and compensate parties accordingly. In one example, network 106 can debit multiple accounts automatically based on offers 103 and/or offers 107 and credit one or more accounts associated with the point of sale 104.

Further to communication with point of sale 104, network 106 has access to the matching offers 107 as well as a plurality of accounts, such as reservation accounts 108 (associated with the offer(s) 103, 107 and an issuer or sponsor responsible for offer), merchant accounts 110, brand accounts 112, and currency accounts 114. Payment network 106 can further include access to other accounts as desired. Accounts can be defined as “in network” accounts, which have direct access by payment network 106 and these can be debited and/or credited by the payment network 106, or “out of network” accounts, which are not directly accessible by payment network 106 and are accessed through one or more intermediaries.

Reservation accounts 108 are associated with a reserve or escrow amount that is associated with one or more offers provided by an issuer or a sponsor. For example, a sponsor may submit a certain amount of dollars to be placed in a reservation account 108. Once the reservation account 108 is empty, no more offers are made and thus payment network 106 would reject an offer 103 presented by consumer 102 that is associated with the reservation account. As such, brands and merchants are able to set specified thresholds in how much money they which to spend for an offer campaign.

Merchant accounts 110 refer to accounts of consumers associated with a particular merchant, for example the merchant associated with the point of sale 104. The merchant account 110 can be used in the settlement of a transaction. For example, consumer 102 may have a gift card or other balance with the merchant. The value of the gift card can be deducted based on the transaction amount. Merchant accounts 110 can also be associated with rewards that represent an earned credit with a merchant. The credit can have an expiration date or be without an expiration date. In one embodiment, value in a merchant account is only available to spend at one or more specified merchants.

Brand accounts 112 refer to accounts of consumers associated with a particular brand, such as a manufacturer that sells goods within a merchant store. The consumer 102 may have access to the particular brand and have an associated brand account 112 that may or may not be associated with the offer 103. In any event, the consumer 102 may have a credit with Brand X (e.g., such as a gift card discussed above with regard to merchant accounts 110) or an offer 103 available at a merchant that provides a discount for a particular good. In addition, the brand accounts 112 can be associated with rewards that represent an earned credit and include an expiration date or be without an expiration date. In one embodiment, value in a brand account is only available to spend with one or more specified brands.

Currency accounts 114 can be directly associated with the consumer 102 and include one or more of a bank account, a charge account, a debit account, a general purpose reloadable card, a health savings account, and/or other accounts associated with processing a transaction in a specified currency at the point of sale 104. In yet a further embodiment, currency account 114 can be a detached debit account associated with a specified demand deposit account (DDA) account and include linking to a credit based currency account as an instant line of credit available in settling transactions. Additionally, currency accounts 114 can be associated with a merchant, a brand and/or other entity for access by payment network 106 to facilitate a transaction. The payment network can optimize, for cost efficacy, to settle the transaction with the least amount of out-of-network processing fees.

It will be appreciated that information associated with each of the merchant accounts 110, brand accounts 112 and currency accounts 114 can be presented to the consumer 102 as desired, for example on the consumer's personal computer or device such as a tablet or phone. The device can further be equipped to form a link to the point of sale 104 transaction and communicate with the point of sale 104 and/or the payment network 106, for example through various communication links (e.g. WiFi, Bluetooth, infrared, near-field communication, cellular). In another embodiment, the device could render an image or series of images that a scanner on the point of sale 104 could use to establish the link to the transaction with the payment network 106. In a further embodiment, the consumer 102 can enter their phone number and pin in to the point of sale 104 terminal device to establish the link to the transaction with the payment network 106.

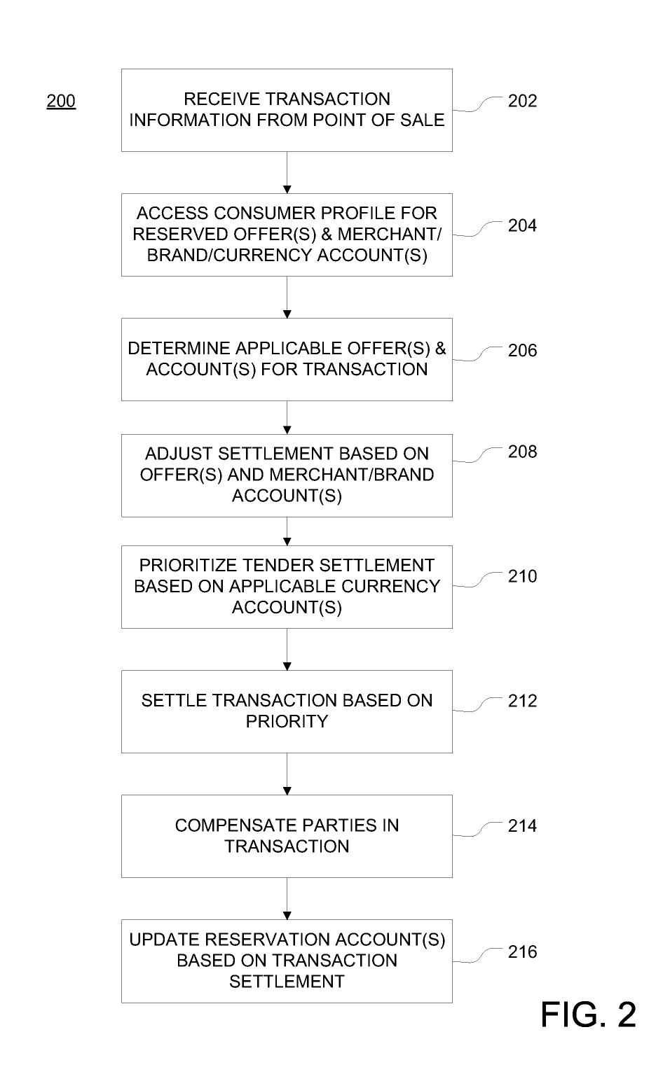

With the above understanding of the transaction environment 100 of FIG. 1 in mind, FIG. 2 is a flow diagram of a method 200 for facilitating a transaction. At step 202, transaction information is received from the point of sale 104, which may include location information (e.g., global positioning system information) associated with the transaction (e.g. location of the consumer, location of the point of sale 104). The transaction information can include an identifier of the consumer 102, the offer 103 and goods and/or services within basket 105 desired to be purchased by the consumer. The transaction information may further include an amount, date and time, merchant identifier, terminal identifier, consumer location, interactivity level, etc. In one example, the consumer 102 can be identified using a consumer's device. In another embodiment, the consumer 102 can be identified only based on a card (e.g., credit or debit card) used during the transaction.

Based on this transaction information, the payment network 106 can access a consumer profile to identify one or more consumer offers and accounts of the consumer 102. In step 206, network 106 can then determine one or more applicable offers and accounts associated with the transaction information provided in step 202. Based on one or more offers, the settlement amount can be adjusted accordingly at step 208. For example, if the offer(s) total $10.00, the transaction amount can be adjusted accordingly as discussed below. For example, the offer 103 and/or matching offer 107 may include a coupon provided by a merchant. The amount of value in the merchant coupon may not be enough to fully satisfy the transaction amount. In such a case, the network 106 can then access one or more currency accounts 114 to finalize the transaction.

Once the applicable accounts are determined, the tender settlement can be prioritized based on the applicable accounts at step 210 for any remaining balance pertaining to the transaction. For example, the consumer 102 may wish to specify that brand accounts 112 are used to satisfy a transaction charge first, followed by a value in a merchant account 110, and further followed by a credit card account associated with a currency account 114. In another embodiment, merchant and brand accounts are automatically prioritized as first to be debited in a transaction and only currency accounts are subject to prioritization. Next, at step 212, the transaction can be settled based on the priority. The priority is implemented until settlement of the transaction has been reached. In one embodiment, the point of sale 104 can tender other forms of acceptable currency from the consumer 102 for any portion of the transaction (e.g. cash, check, other forms of store credit, traditional manufacturers coupons, debit or credit cards provided directly to point of sale 104 by consumer 102, etc). At step 214, parties in the transaction are compensated. For example, a merchant can be compensated based on its role in the transaction. At step 216, one or more reservation account(s) are updated based on the transaction settlement.

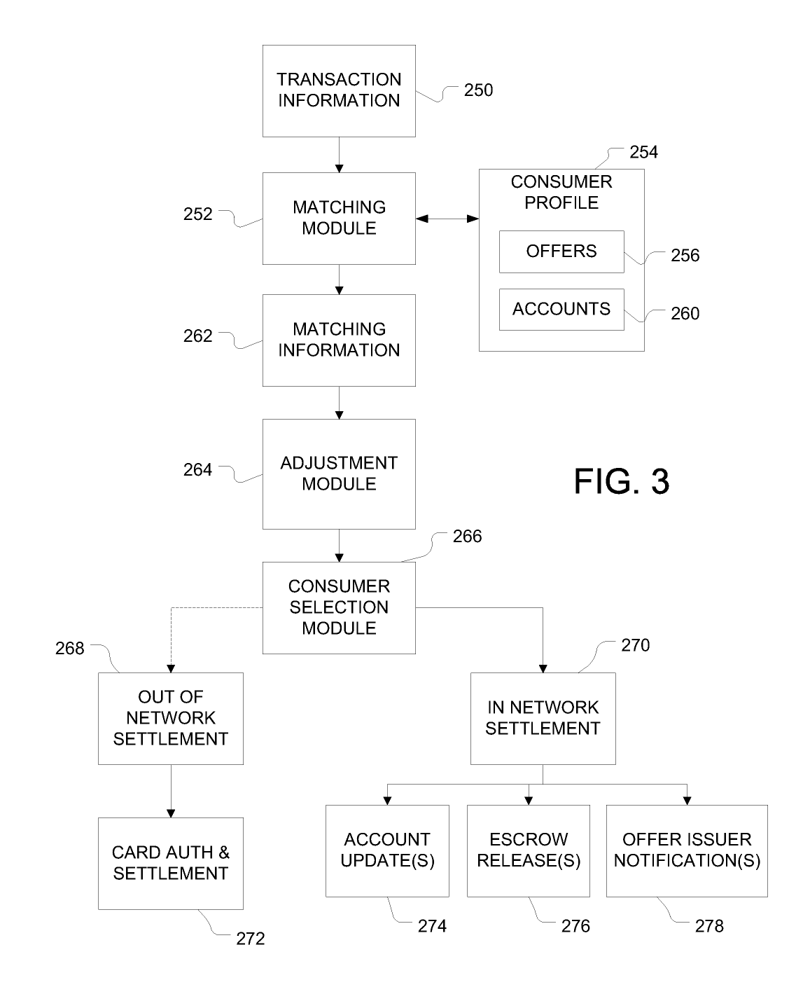

Given the above method 200 for facilitating a transaction, FIG. 3 illustrates logic components utilized in facilitating the transaction and utilized by the payment network 106. One component is transaction information 250 as discussed above. In one embodiment, the transaction information 250 is entered by a consumer 102 on a consumer device that is then communicated to payment network 106. In another embodiment, the transaction information is generated by the point of sale 104 based on interaction with the consumer 102 (i.e., the consumer 102 providing a consumer identifier and basket 105). The transaction information 250 is provided to a matching module 252, which associates elements with the transaction based on the transaction information 250. In particular, the matching module 252 accesses a consumer profile 254 associated with the consumer identifier provided by the transaction information 250. Associated with the consumer profile 254 include one or more offers 256 and accounts 260. Based on the transaction information 250, the matching module 252 associates the applicable one or more offers 256 and one or more accounts 260. Once identifying the particular elements, the matching module 252 produces matching information 262.

The matching information 262 including the identified one or more offers and accounts is then provided to a payment network adjustment module 264. The adjustment module 264 adjusts the transaction amount provided within the transaction information 250 based on the matching information 262. For example, if an offer is identified that provides a $10.00 discount, module 264 can deduct $10.00 from the transaction amount, or if an offer is identified that adjusts the price of item down, module 264 can deduct the amount according to the value it was adjusted down. As such, merchants that charge different amounts for an item, or that have predetermined arrangements with the offer issuer can be compensated accordingly. After adjustments are made to the transaction amount, any additional remaining balance is provided to a consumer selection module 266. The consumer selection module 266 allows the consumer to select one or more currency accounts 114 for settlement of the remaining balance of the transaction. In certain situations, the consumer selection module 266 is not accessed since the remaining balance may be zero or the consumer can select to pay the remaining balance with cash. After receiving selection from the consumer, out of network settlement 268 and in network settlement 270 perform final processing on the transaction. If a currency account 114 outside of the payment network is selected (such as a conventional credit or debit card), a card authorization and settlement procedure 272 is performed. The procedure 272 is performed outside of the payment network 106 and can be a conventional debit or credit card transaction. The in network settlement 270 can perform various procedures such as an account update 274 that adjusts various accounts associated with the payment network 106, escrow release(s) 276 that release currency stored within a reservation account and offer issuer notification(s) 276 that notify a sponsor or other issuer of another offer that the offer has been accepted and other information as desired.

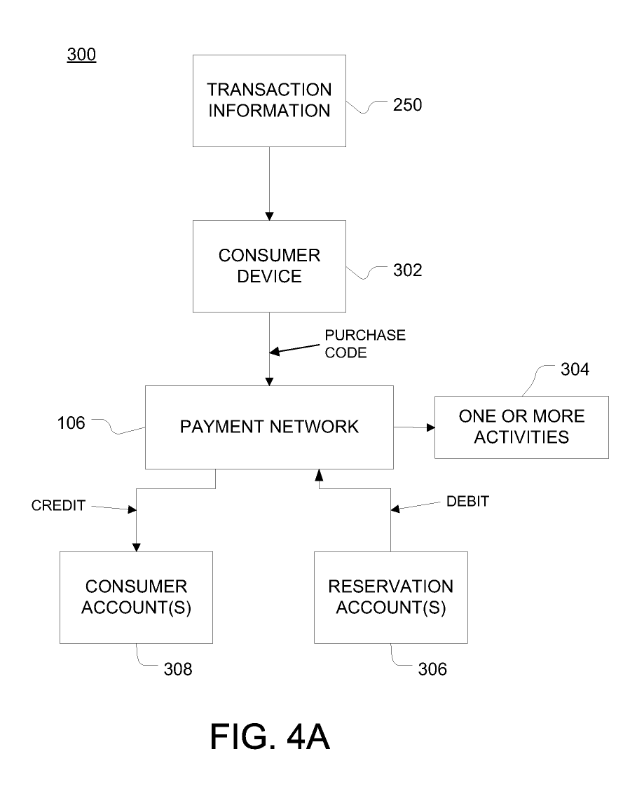

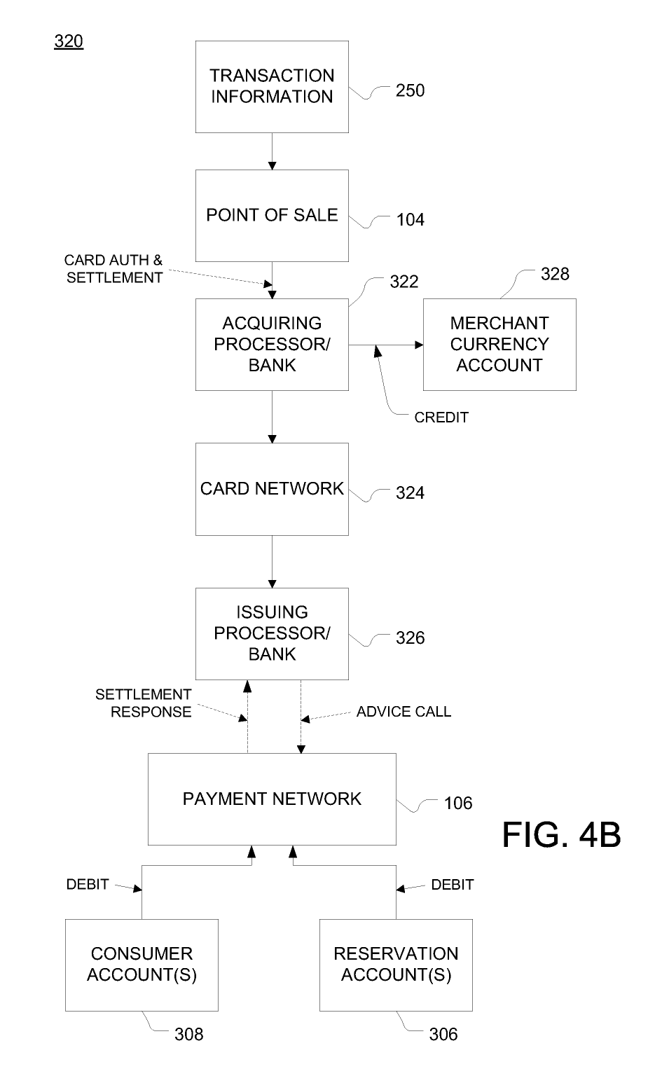

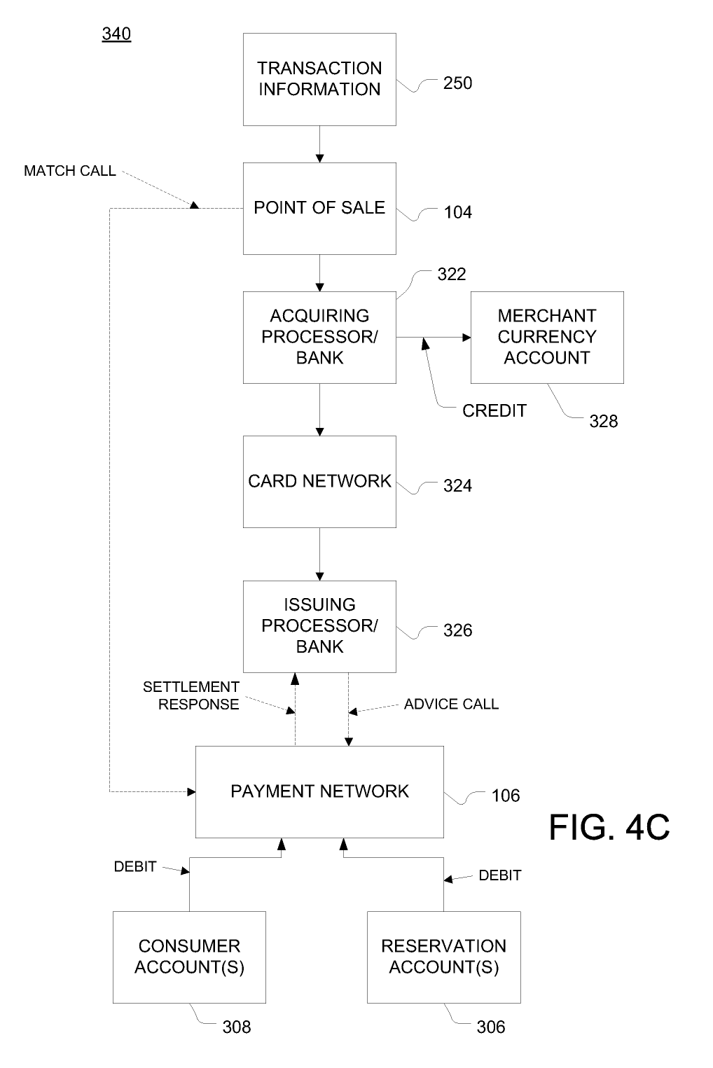

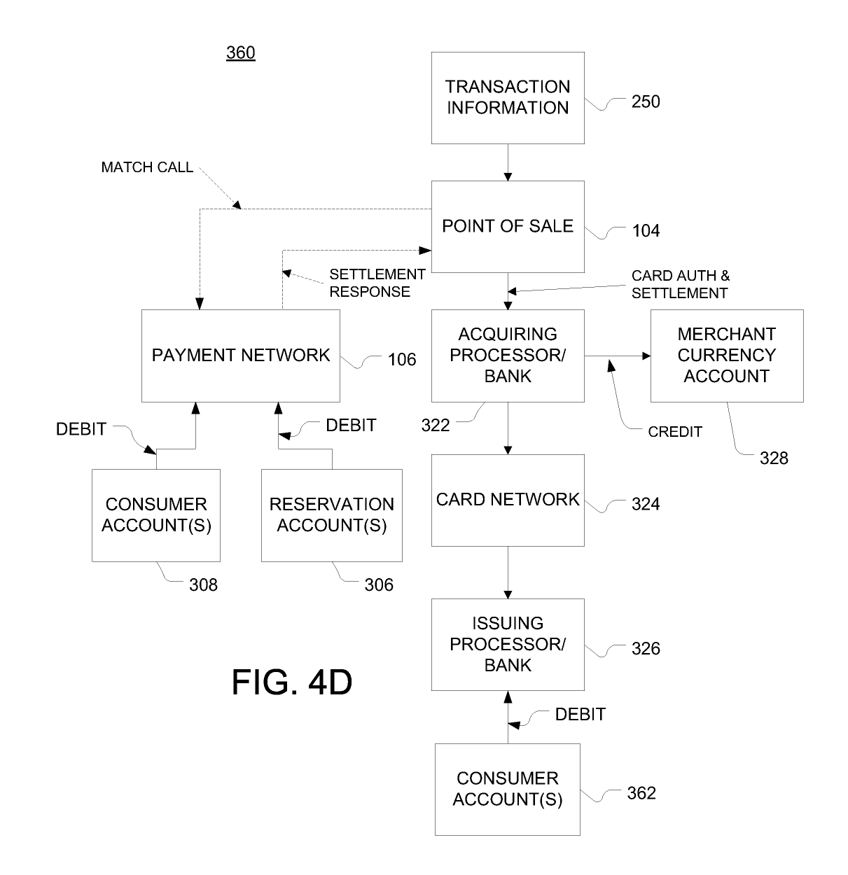

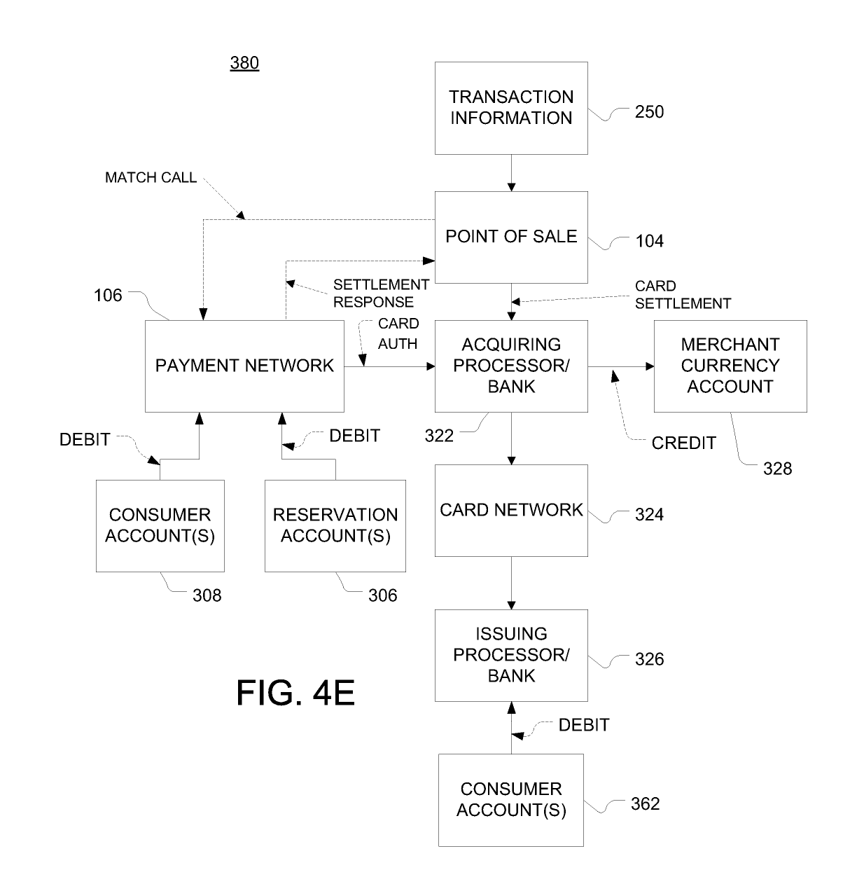

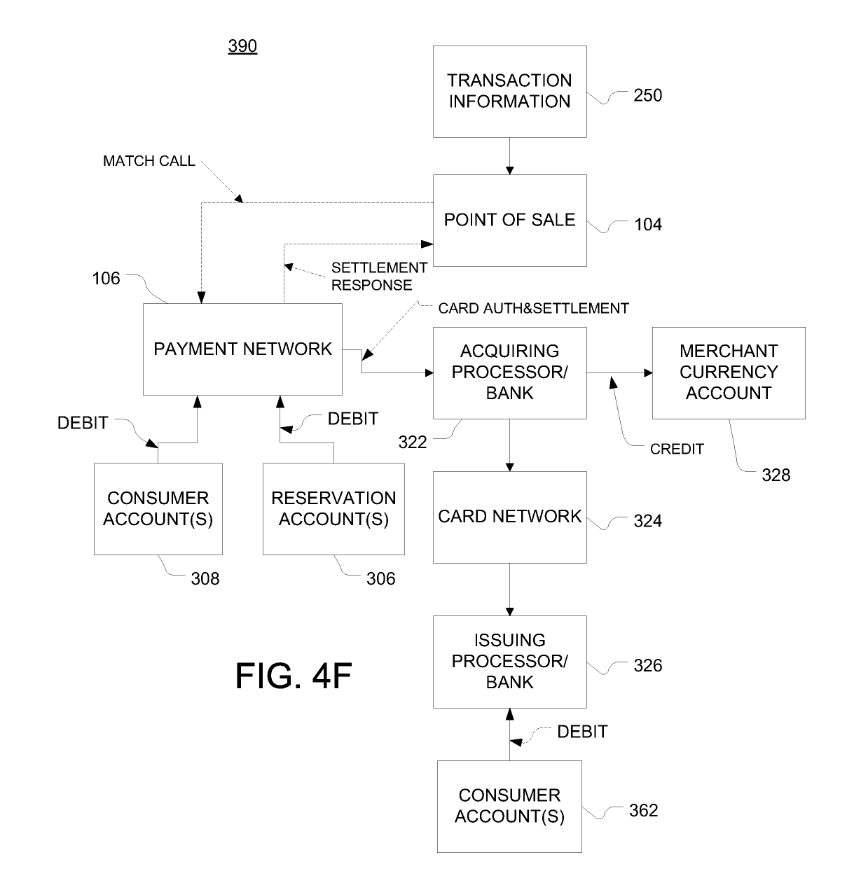

Given the above description of the method 200 of facilitating a transaction in FIG. 2 and the logic components in FIG. 3, FIGS. 4A-4F are schematic diagrams of various transaction scenarios that can be facilitated by payment network 106. FIG. 4A illustrates a transaction scenario 300 where a point of sale is not directly involved with providing compensation to a consumer for accepting an offer and where a consumer 102 directly communicates with payment network 106 to accept the offer and received compensation. In scenario 300, a consumer 102 has already purchased goods and/or services from a point of sale 104 and transaction information 250 is accessed by a consumer device 302. For example, the consumer device 302 can be a mobile device, phone, tablet, personal computer, etc. Based on the transaction information 250, the consumer device 302 can provide a purchase code to the payment network 106. In one example, the purchase code can be a receipt detailing purchase of a particular product. In another example, the purchase code can be affixed to the product or inside the product packaging (e.g., under a bottle cap) that will otherwise provide a unique code indicative of proof of a purchase of the product. Using the purchase code, the payment network 106 can determine an applicable offer relative to the transaction information 250. For example, the offer may be a $0.50 rebate to the consumer for purchasing a specified soda brand. If desired, the credit can further be implemented when the consumer completes one or more engagements 304 such as a video or survey. Based on the offer identified by the payment network 106, a reservation account 306 associated with the offer can be debited and the debit can be applied as a credit to a consumer account 308.

FIG. 4B illustrates a further transaction scenario 320 wherein transaction information 250 is provided to a point of sale 104. In scenario 320, the transaction information 250 includes a card number associated with the consumer that serves as an identifier of the consumer. In a particular embodiment, the card number is accessed as in a conventional debit/credit card transaction such that the point of sale 104 need not have any direct connection with payment network 106. The point of sale 104 provides the transaction information to an acquiring processor/bank 322 associated with the point of sale 104. The information provided to the acquiring processor 322 can include an authorization request and a settlement request as well as other transaction information provided in a conventional card transaction such as card number, merchant identifier, amount of transaction, etc. The acquiring processor/bank 322 provides the transaction information 250 to a card network 324. The card network 324 can identify the issuing processor/bank 326 associated with the consumer card provided in the transaction information 250.

The issuing processor/bank 326 then produces an advice call to payment network 106 in order to determine final settlement for the transaction. Based on the transaction information provided in the advice call, the payment network 106 can identify one or more offers and/or rewards associated with the transaction. The payment network 106 can then debit the reservation account(s) 306 and consumer account(s) 308 accordingly in order to provide assurance of the full transaction amount provided with the transaction information 250. For example, an offer for $10.00 can be made to a consumer wherein the action includes spending $50.00 at select merchants. They payment network 106, based on the transaction information, matches the consumer identifier, the merchant identifier and the amount with the transaction and applies the offer to the transaction. In this situation, the reservation account 306 is debited $10.00 (the amount of the offer) and the consumer and the consumer account 308 is debited $40.00 (the remaining balance after the offer has been processed). The payment network 106 can then provide a settlement response to the issuing processor/bank 326 that assures payment will be made for the transaction amount (e.g., $50.00) in the transaction information 250. This information is then provided back to the acquiring processor/bank 322, which can issue a credit to a merchant currency account 328 associated with the point of sale 104. The credit to account 328 is applied for the full transaction amount less processing fees that can occur at one or more points along scenario 320. As such, point of sale 104 need not be aware of the credit coming from two or more separate sources (e.g., accounts 306 and 308) and thus point of sale 104 need not have a direct association with the payment network 106. Furthermore, a consumer 102 can easily accept an offer without having to notify the point of sale 104 of the offer.

FIG. 4C illustrates an alternative transaction scenario 340 in which transaction information 250 is provided to point of sale 104, similar to scenario 320 in FIG. 4B. When point of sale 104 determines that a card presented by the consumer 102 is associated with the payment network 106, a match call is issued to the payment network 106. Thus, point of sale 104 has direct communication with payment network 106, different from scenario 320. The match call can include product/service information associated with the transaction. For example, the product information can include one or more UPC codes, or equivalent, which uniquely identify products/services provided for purchase. In one embodiment, only specified goods are provided in the match call such that only a portion of the select components are sent with the match call. In a further embodiment, the payment network 106 suppresses from any persistence the portion of the items that did not have a match. In one embodiment, upon receiving the response from the match call, the point of sale 104 then provides card information to the acquiring processor/bank 322. In another embodiment, the point of sale 104 simultaneously makes the match call to the payment network 106 and provides the card and transaction information to the acquiring processor/bank 322. The acquiring processor/bank 322, card network 324 and issuing processor/bank 326 process the transaction information as discussed above with regard to transaction scenario 320. The issuing processor/bank 326 then issues an advice call to the payment network 106. In response, the payment network 106 provides a settlement response to the issuing processor/bank 326. However, in this scenario, payment network 106 has access to one or more products/services involved in the transaction based on the match call. As such, the payment network 106 can debit one or more of the reservation accounts 306 and/or consumer accounts 308 based on information from the match call. In any event, point of sale 104 need not be modified substantially to process offers in accordance with scenario 340. Furthermore, point of sale 104 can suppress/filter information provided to payment network 106. If desired, the payment network 106 can provide a confirmation, a network transaction identification number or other information to point of sale 104 as desired; which can also be provided within the transaction information provided to the acquiring processor/bank 322 along with the card.

FIG. 4D illustrates yet another transaction scenario 360 in which transaction information 250 is provided to a point of sale 104. In this scenario 360, the payment network 106 has direct communication with the point of sale 104. The point of sale 104 then issues a match call to the payment network 106 to identify one or more offers and/or one or more accounts associated with the transaction information 250, as discussed above with respect to FIGS. 2 and 3. With the information from the match call, payment network 106 can debit the one or more reservation accounts 306 and one or more consumer accounts 308. In the event the reservation accounts 306 do not fully satisfy the transaction amount, a settlement response can be provided assuring a portion of the transaction amount and also card information to the point of sale 104 in order to issue a card authorization and settlement request to the acquiring processor/bank 322.

As illustrated in FIG. 4E, transaction scenario 380 involves a card authorization from the payment network 106 to the acquiring processor/bank 322. In one embodiment, this authorization from the payment network 106 can be processed as an agent for or on behalf of merchant. The settlement response provided from the payment network 106 to the point of sale 104 that includes authorization information provided in processing the card authorization. The point of sale 104 can then request card settlement at a later time to the acquiring processor/bank 322. For example, the point of sale 104 may issue multiple settlement requests in a batch acquired during a certain period of time (e.g., once daily, twice daily).

In FIG. 4F, a further transaction scenario 390 is illustrated in which the payment network 106 provides both the card authorization and settlement request to the acquiring processor/bank 322. As such, point of sale 104 can be independent and not be provided with a direct line of communication to the acquiring processor/bank 322.

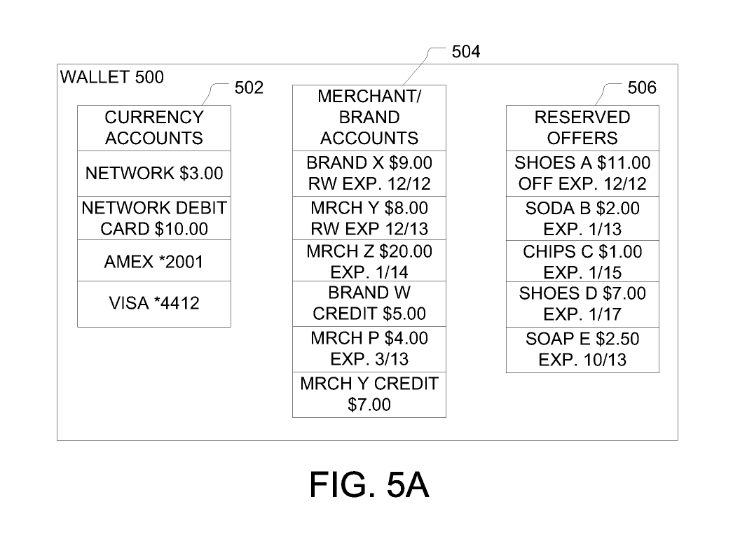

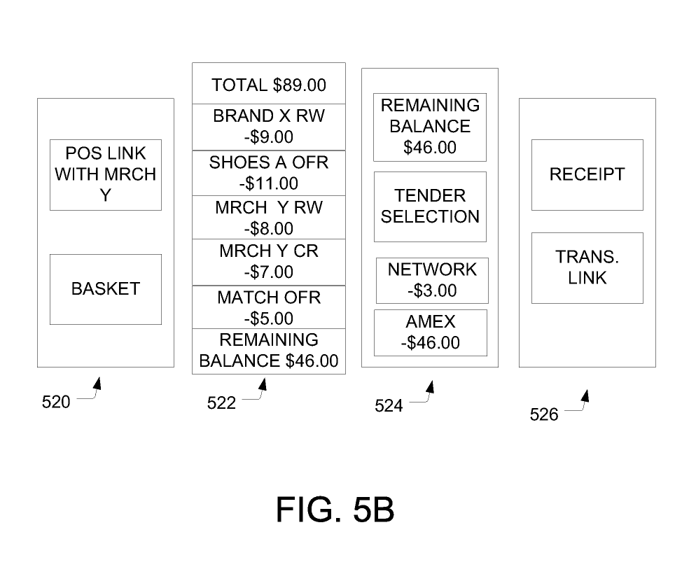

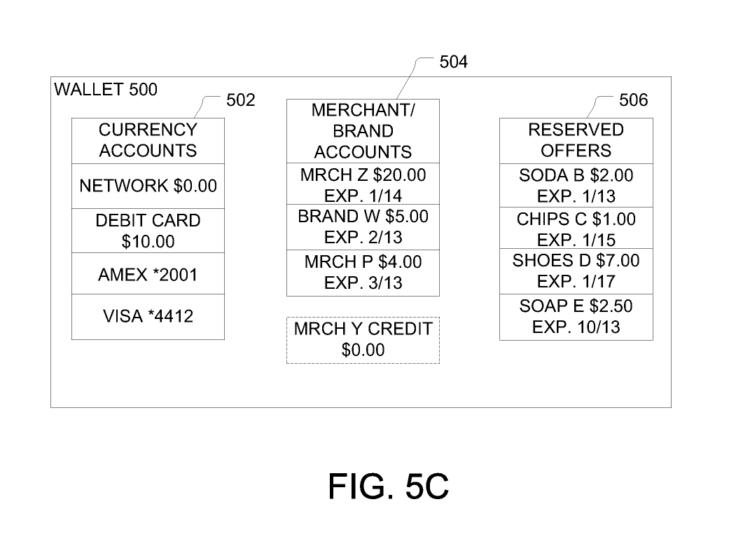

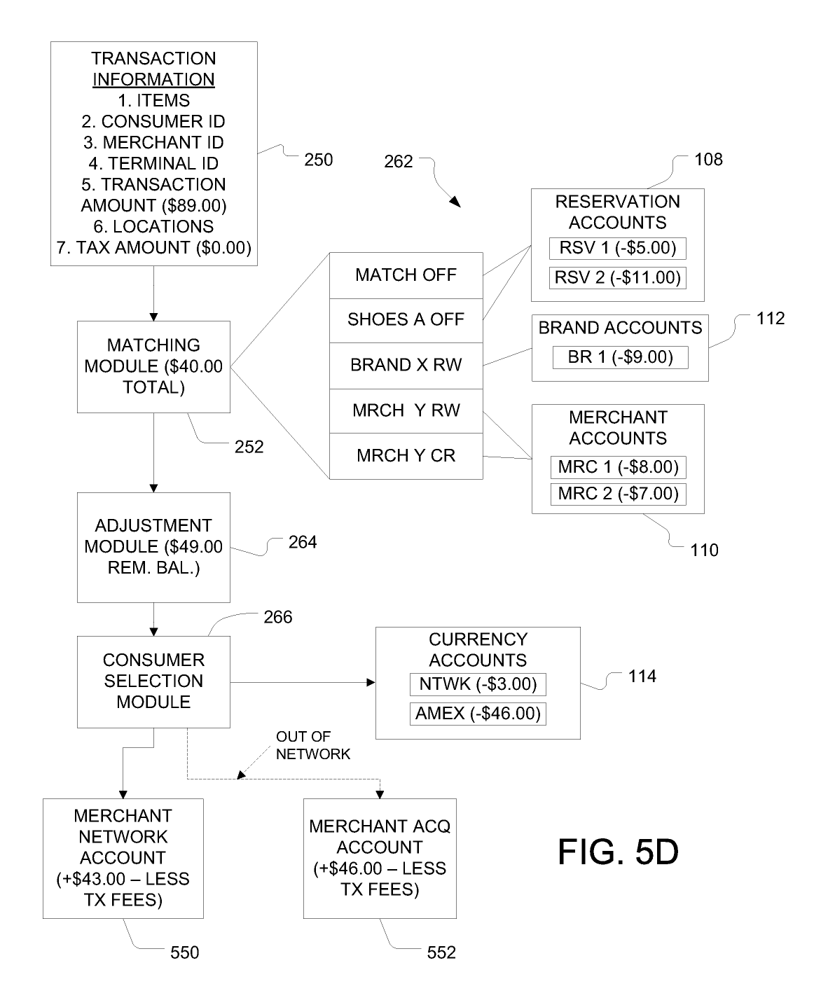

With the above description of various transaction scenarios 4A through 4E described, FIG. 5A illustrates a digital wallet 500 that can be displayed on a device of a consumer 102 during a transaction. The wallet includes a currency accounts list 502, a merchant/brand accounts list 504 and a reserved offers list 506. The currency accounts list 502 lists currency accounts that can be utilized during a transaction. Merchant/brand accounts list 504 illustrates different credits and/or rewards associated with the consumer for use during a transaction. Similarly, offers list 506 illustrate reserved offers for use during a transaction.

FIG. 5B illustrates successive screens that can be displayed to a consumer during a transaction. In screen 520, a point of sale link is established with merchant Y. The basket can also be displayed on screen 520. Based on the basket and matching information associated with the transaction, screen 522 can display a total as well as various offers and/or rewards associated with the transaction in a transaction summary. In one embodiment, as the matches are determined they can be displayed in real time on screen 522. In screen 524, the remaining balance can be shown as well as a tender selection interface for the consumer to select a priority of tender for the transaction. In screen 524, the consumer has selected the Amex account for tender settlement. In screen 526, a receipt is shown illustrating transaction information that includes the offers, rewards, credits and accounts associated with the transaction.

Based on the transaction, updated digital wallet 500 is illustrated in FIG. 5C. The accounts list 502 has been updated to illustrate that the network credit has been debited to zero. Moreover, the brand X, merchandise Y rewards and merchandise Y credits, have been removed from rewards list 504. Additionally, the brand X shows the shoes A offer has been removed from offers list 506.

Given the transaction referenced in FIGS. 5A-5C, logic components are illustrated in FIG. 5D to provide an understanding of facilitation of the transaction. In FIG. 5D, the transaction information 250 is shown to have five elements, including 1. Products, 2. Consumer ID, 3. Merchant ID, 4. Terminal ID, 5. Transaction Amount ($89.00), 6. Locations, 7. Tax Amounts ($0.00). The transaction information 250 can include other information such as date, time, device, etc. as discussed above. The transaction information 250 is provided to matching module 252, which identifies matching information 262 from a consumer profile.

As illustrated, the matching information 262 includes a matching offer (MATCH OFR), a reserved offer (SHOES A OFR), a brand reward (BRAND X RW), a merchant reward (MRCH Y RW) and a merchant credit (MRCH Y CR) associated with the consumer profile and matching the transaction information 252. In particular, the MATCH OFR was matched based on the Consumer ID as identifying a consumer that is eligible for the matching offer. The SHOES A OFR was matched since the consumer had shoes A in the Products. Furthermore, the BRAND X RW, MRCH Y RW and MRCH Y CR were identified based on the Consumer ID.

As illustrated, the MATCH OFR and SHOES A OFR were associated with reservation accounts RSV 1 and RSV 2, respectively. Thus, upon completion of the transaction, these reservation accounts will be debited based on the MATCH OFR and SHOES A OFR being involved in the transaction. The BRAND X RW was associated with a particular brand account BR 1, which will be debited upon completion of the transaction. Merchant accounts MRCH 1 and MRCH 2 were also associated with the transaction as being tied to MRCH Y RW and MRCH Y CR, respectively.

In all, the matching information 262 identifies $40.00 from reservation, brand and merchant accounts that can be applied toward the transaction based on the transaction information 250. The adjustment module 264 subtracts the matching module 252 total to compute the remaining balance ($49.00). The remaining balance is sent to the consumer selection module 266, where a consumer can select which currency accounts 114 to use to finally settle the transaction. As illustrated, the consumer selects currency account NTWK for $3.00 and the currency account AMEX for $46.00 to settle the remaining balance of $49.00. Based on this selection, a merchant network account 550 can be credited $43.00 less transaction fees (if applicable). Additionally, an out of network request can be sent to authorize and settle $46.00 from the AMEX account to a merchant acquisition account 552, less transaction fees (if applicable).

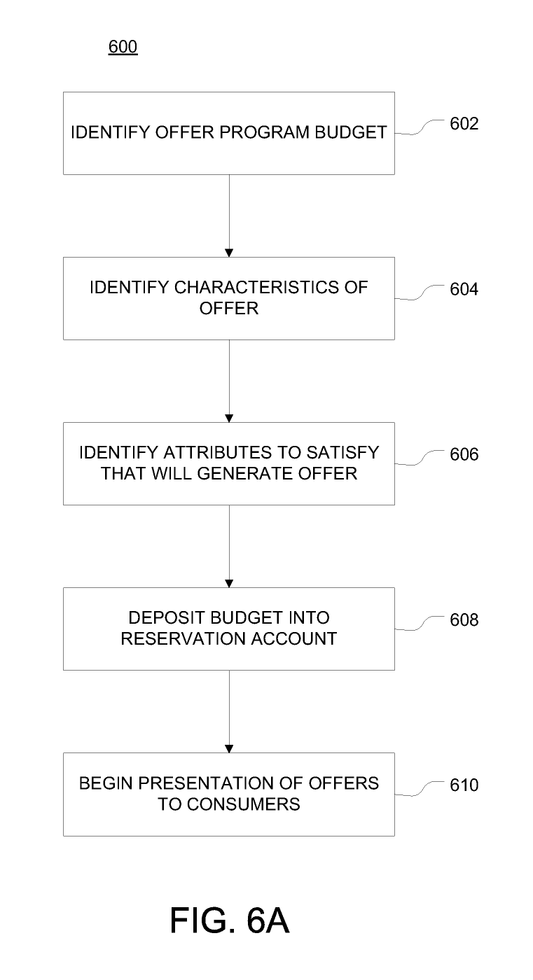

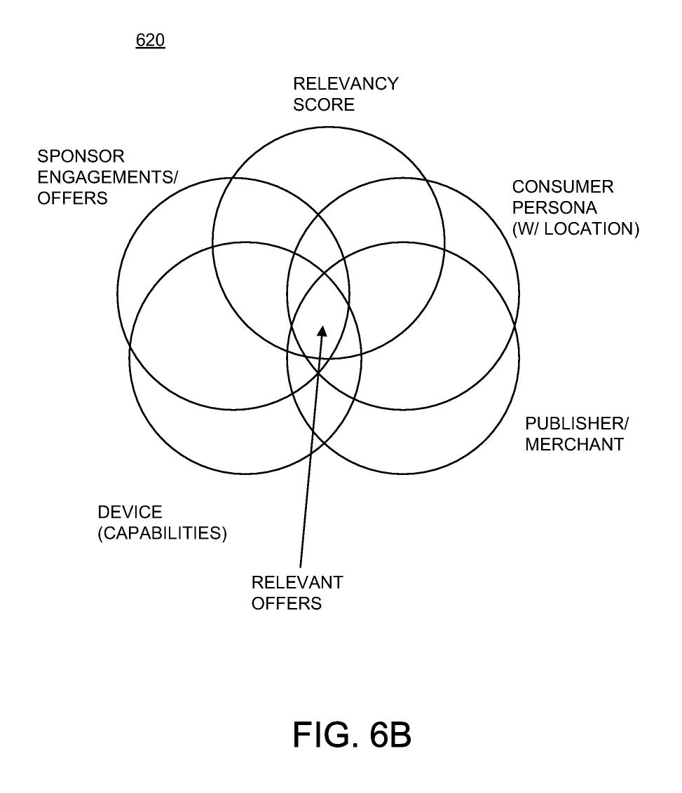

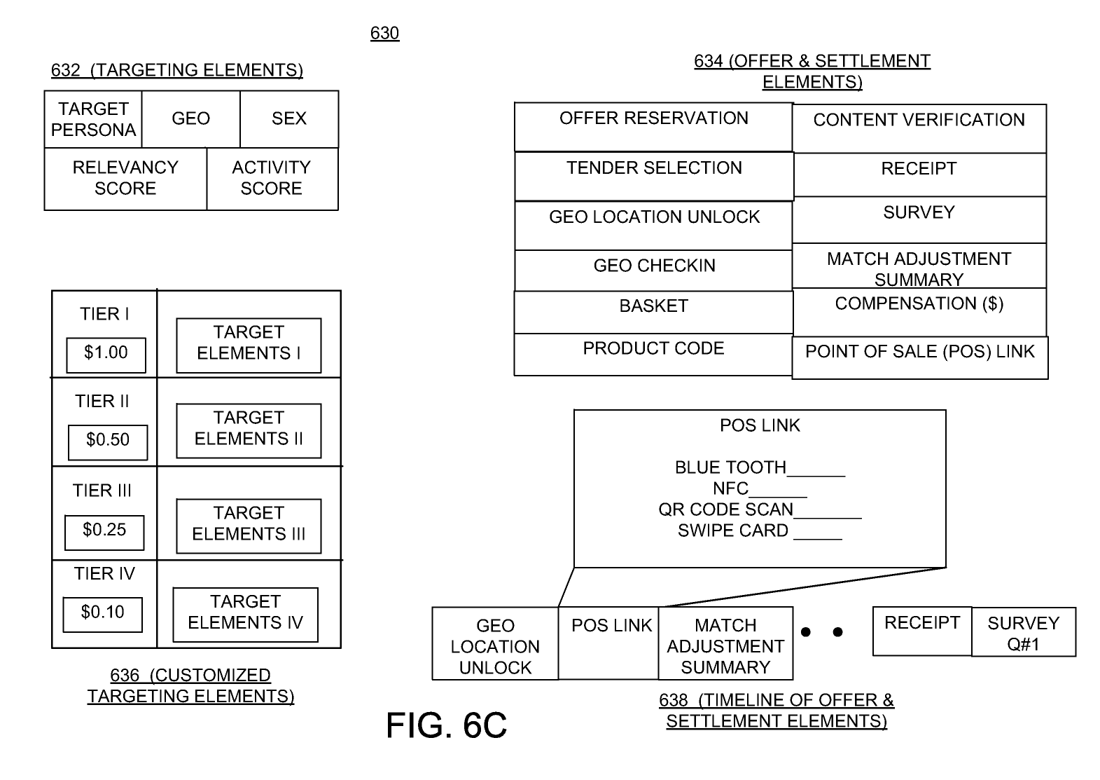

FIG. 6A presents a flow diagram 600 for implementing an offer campaign where a plurality of offers are presented and managed throughout payment network 106. At step 602, an offer program budget is identified. As discussed above, the budget can limit exposure of the sponsor or issuer to a set amount. Next, characteristics of the offer are identified at step 604. The characteristics can include value, time, elements, number, activities, etc. For example, a first purchase of a product (for example associated with a UPC) can include an instant rebate. Unique offers can also be generated, such as the first 1,000 consumers to buy a product to accept an offer get a $100.00 discount and the second 10,000 consumers get a $50.00 discount. Offers can also vary by time, for example having a $1.00 value between 9:00 pm and 11:59 pm and $0.50 at all other times. Furthermore, offers can be dynamically optimized for efficacy across different market segments and regions. For example, offers that don't meet particular thresholds can be eliminated, whereas successful offers can be replicated to different regions or market segments. Offers can further be based on multiple consumers, where if a number of consumers purchase a product (e.g. within a specific time/merchant/region etc), an offer can be triggered. Additionally, merchants and brands can combine to present offers. For example, a merchant can provide an extra discount, as an extension to or alongside an offer that a brand created, if a consumer purchases a particular brand/product. Offers can also be based on a frequency with which a consumer purchases from a merchant and/or purchases a particular brand. For example, each successive purchase in a week can obtain a successive higher value offer (first purchase=$0.50 discount, second purchase=$1.00 discount, and so on). Brands that have multiple different products can provide incentives across all of their products. For example, if a consumer purchases $20.00 of any Brand X goods (e.g. within a specific time or at a specific merchant), they receive a $5.00 discount for their next purchase of any Brand X goods.

At step 606, activities that are satisfied to generate an offer are identified. In one embodiment, a suitable filter 620 shown in FIG. 6B is used to identify relevant offers for a consumer. Once the variables are identified in steps 602-606, the budget can be deposited into the reservation account at step 608. Next, the presentation of offers to consumers can begin at step 610.

FIG. 6C is a block diagram of an interface 630 for creating and implementing an offer campaign. The interface 630 displays targeting elements 632, offer and settlement elements 634, customized targeting elements 636 and a timeline of offer and settlement elements 638. Targeting elements 632 present selectable elements relevant to a sponsor of an offer in a campaign. A plurality of targeting elements can be configured within a plurality of tiers. Exemplary elements include a target persona (e.g., defined by multiple attributes of a consumer profile), a geographic location, a sex of the consumer, a relevancy score and/or an activity score. Each of these targeting elements can be selected and placed within respective tiers of the customized targeting elements 636. In the example interface 630 that is shown, four tiers provide various target elements. Each tier is also associated with a particular offer value based on the target elements desired for a particular campaign.

The offer and settlement elements 634 are selectable within the interface 630 and can be selected and positioned within the timeline of elements 638. In the example shown, the elements 634 identify actions that are used during acceptance of an offer and can include an offer reservation, a geographic location unlock, a geographic check-in, a basket, a verification barcode scan, a receipt, a survey, a match adjustment summary, compensation and a point of sale link. These elements 634 are selected and positioned within a timeline 638. It is worth noting that the timeline need not be linear as shown, but may also include various branches depending upon survey results or activity of a consumer based on engagement during the elements 634. Additionally, the start and end date are established and can optionally include specific time windows for completion. It is also worth noting that the intent is for the payment network 106 to take a background role as the elements allow the brands to deliver a branded experience to the consumer. For example, merchant A may have varying point of sale 102 capabilities (e.g. near field communication, QR code capable scanner/camera, payment terminal, etc.) across locations, coupled with the consumers identification capabilities (e.g. device capabilities, card, etc); where the settlement element capabilities and timeline/flow will vary slightly based upon the capability matching between the point of sale and the consumer identifier 102a-d. In this example, point of sale 104 type 1 can have a QR code capable scanner/camera for interacting with the consumer 102.

A description of various offer and settlement elements is provided below:

Offer Reservation: When a consumer is within a specified “trading radius” (x miles from a geo location) an offer could be reserved. In one embodiment this reservation could be used in conjunction with a “GEO Checkin.

GEO Checkin: at GEO location—when a consumer's location enabled computing device is within a defined location footprint. In one embodiment this could be used as the only element in the “GEO checkin” (unverified) that would complete the offer, based on a global positioning system, near field communication or other location technology, for example those utilizing electromagnetic variations.

Content Verification: 1D/2D Barcode, QR Code, image, digital watermark, and/or audio watermark in conjunction with a GEO unlock element or on its own, the camera/mic on a GPS enabled smartphone can be used to take a picture/video/scan. Content can be provided by the offer creator, or generated by the payment network to be unique to the consumer, product, geo location, or any other parameter provided by the creator.

Tender selection: refers to a customizable element where the consumer selects from a plurality of tenders for settlement.

Basket: refers to items assembled in a physical or virtual basket for purchase.

Receipt: refers to a receipt detailing components of the transaction including the basket as well as offers and accounts applicable to the transaction.

Point of sale link: refers to a link between a unique consumer identifier and a transaction at the point of sale and can be achieved through a wired or wireless connection, as well as identify capabilities associated with the consumer device and/or the point of sale.

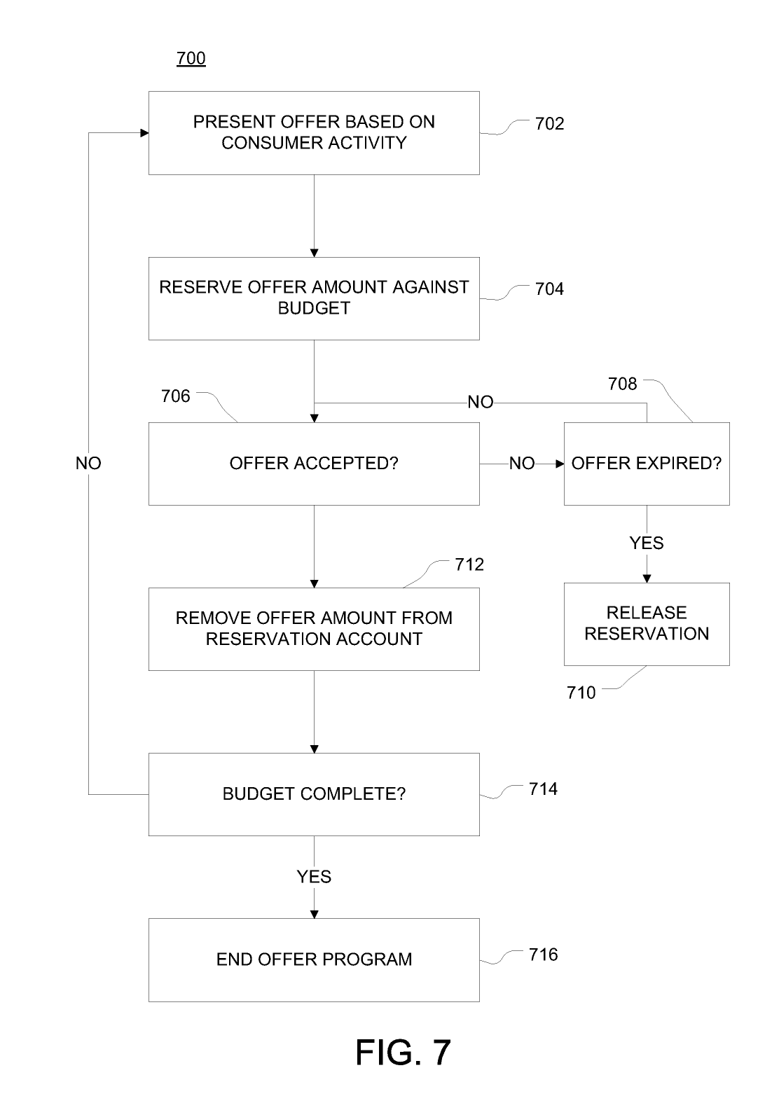

FIG. 7 is a flow diagram of a method 700 for managing offers that are presented to a consumer. At step 702, an offer is presented to consumer based on consumer activity. For example, a consumer may watch an advertisement associated with a particular item that the consumer may want to purchase. Once the offer is presented at step 702, the offer value is reserved against the budget at step 704. For example, if the offer involves a savings of ten dollars for the consumer, ten dollars of the reservation account can be reserved. Once the offer value is reserved, it is determined whether or not the offer is accepted at step 706. In one example, the offer may be accepted by the consumer by visiting a merchant store and purchasing a particular item. The offer may or may not also be associated with a start date and time and or an expiration date and time. The offer expiration date and/or time can be independent of a time for reservation of the offer. For example, a consumer may have to reserve an offer within one week, while the offer itself can be accepted within fourteen (14) days. In a further embodiment, the consumer 102 can be presented with options for facilitating a transaction based on the offer. For example, the consumer 102 can utilize a “buy it now” feature that will allow the consumer 102 to purchase a particular item and, for example, download the item (e.g., software, music, article), have the item shipped to the consumer or otherwise acquire the item at a retail location as specified by the payment network. In the latter case for example, the retail location can be multiple locations associated with a particular merchant, multiple locations associated with multiple merchants, or a single merchant location. In yet a further embodiment, the offer can be reserved for an extended length of time by paying an extension fee. The offer can either allow this extension fee can be applied during a transaction undertaken with the offer or not. In any event, if the offer is not accepted, a determination is made at step 708 as to whether the offer has expired. If the offer has expired, the reserved value at step 704 is released back into the reservation account. In the event that the offer is accepted at 706, the offer amount is removed from the reservation account at step 712. Next, it is determined at step 714 whether or not the offer budget is complete. If it is determined that the budget is not complete, other offers can be made to consumers at step 702. However, if the budget is determined to be complete at step 714, the offer program is ended at step 716.

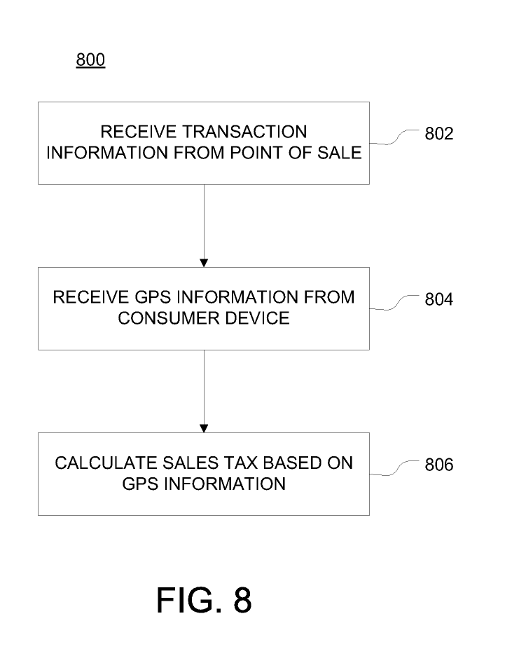

FIG. 8 is a flow diagram of method 800 for calculating a sales tax based on an offer that may be associated with multiple locations. At step 802, transaction information is received from the point of sale. This transaction information can include a purchase amount and other information as desired. Next, at step 804, GPS information is received by a consumer device. Next, at step 806, a sales tax can be calculated based on the GPS information. The tax information can be calculated based on the offer as well. For example, a $0.50 discount that is not applied at the point of sale can be taxed differently in different jurisdictions.

Although the present invention has been described with reference to preferred embodiments, workers skilled in the art will recognize that changes can be made in form and detail without departing from the spirit and scope of the present invention.

1. A method, comprising:
issuing an offer to a consumer, the offer being associated with the consumer and including at least one action for acceptance;
reserving an offer amount associated with the offer and a reservation account;
initiating a transaction between the consumer and a merchant, the transaction including the action to accept the offer and an identification of at least one good or service purchased in the transaction;
communicating an identification of the at least one good or service to a payment network;
debiting the reservation account the offer amount associated with the offer;
crediting at least one of a consumer account and a merchant account the offer amount associated with the offer.

2. The method of claim 1, wherein the consumer account is a debit or credit card account.

3. The method of claim 1, further comprising:
identifying a merchant credit associated with the consumer;
adjusting the transaction amount due to the merchant based on the merchant credit.

4. The method of claim 1, wherein the action for acceptance includes purchasing a particular good and/or service.

5. The method of claim 1, further comprising;
accessing a priority list of the one or more consumer accounts indicative of a desired priority of settlement for the transaction;
debiting the one or more consumer accounts as a function of the priority list.

6. The method of claim 1, further comprising:
debiting a first consumer account associated with one of a brand and a merchant a first amount that is less than the consumer amount;
presenting a list of a plurality of currency consumer accounts to be debited a second amount that equals a difference between the consumer amount and the first amount;
selecting one or more currency accounts from the list of the plurality of currency accounts; and
debiting the selected one or more currency accounts the second amount.

7. The method of claim 1, further comprising:
presenting a plurality of tender settlement options to the consumer, each settlement option associated with an account of the consumer.

8. The method of claim 1, further comprising:
receiving transaction information identifying the consumer;
accessing a profile of the consumer using the transaction information; and
identifying the offer based on the profile of the consumer.

9. The method of claim 1, further comprising:
receiving transaction information indicative of a basket of goods and/or services involved in the transaction from the merchant to a payment network;
matching one or more of the goods and/or services involved in the transaction with the offer based on the transaction information.

10. The method of claim 9, further comprising:
receiving transaction information identifying the consumer;
accessing a profile of the consumer using the transaction information;
identifying the offer issued to the consumer based on the consumer profile; and
identify the one or more consumer accounts to be debited based on the consumer profile.

11. The method of claim 9, further comprising:
identifying a second offer issued to the consumer based on the transaction information, the second offer including a value contributing to the offer amount.

12. The method of claim 1, further comprising:
compensating a party facilitating issuance of the offer to the consumer.

13. The method of claim 1, further comprising:
receiving an indication that a second consumer has shared the offer with the first-mentioned consumer;
receiving an indication that the first-mentioned consumer has completed the transaction associated with the offer;
compensating the second consumer upon completion of the transaction.

14. The method of claim 1, further comprising:
receiving location information for the consumer during the transaction;
calculating a sales tax associated with the offer amount based on the location of the consumer and transaction information received from merchant.

15. The method of claim 1, further comprising:
identifying a budget for a campaign associated with the offer targeting a plurality of consumers, the budget identifying a total value for offers issued during the campaign;
determining if the budget has been reached.

16. The method of claim 15, further comprising:
accessing a plurality of consumer profiles based on the campaign;
identifying a plurality of target consumers based on the plurality of consumer profiles;
issuing offers to the plurality of target consumers.

17. The method of claim 15, further comprising:
accessing a plurality of consumer profiles based on the campaign;
identifying a plurality of target consumer groups based on the plurality of consumer profiles;
defining a first offer amount for a first target consumer group in the plurality of target consumer groups;
defining a second offer amount for a second target consumer group in the plurality of target consumer groups, the second offer amount being different than the first offer amount;
issuing offers with the first offer amount to the first target consumer group and offers with the second offer amount to the second target consumer group.

18. The method of claim 1, further comprising:
accessing a profile associated with the consumer;
upon a request or permission of the consumer, identifying a merchant consumer account associated with the consumer and maintained by the merchant;
linking the profile with the merchant consumer account such that the profile includes information associated with the merchant consumer account.

19. The method of claim 1, further comprising:
accessing a profile associated with the consumer;
upon a request or permission of the consumer, identifying a brand consumer account associated with the consumer and maintained by a brand associated with the offer;
linking the profile with the brand consumer account such that the profile includes information associated with the brand consumer account.

20. The method of claim 1, further comprising:
associating the offer with a good and or service in the transaction that has been returned to the merchant;
crediting the offer amount to the reservation account and debiting the merchant account the offer amount.

21. The method of claim 1, further comprising:
accessing the reservation accounts and one or more consumer accounts using the payment network;
communicating a authorization response to the merchant that assures payment of the amount.

22. The method of claim 1, further comprising:
accessing the reservation accounts and one or more consumer accounts using the payment network;
communicating a settlement response to the merchant that assures payment of the amount.
